(19) United States
(12) Patent Application Publication
(10) Pub. No.: US 2021/0004131 A1
(43) Pub. Date: Jan. 7, 2021

(54) HIGHLIGHTS VIDEO PLAYER

(71) Applicant: Microsoft Technology Licensing, LLC, Redmond, WA (US)

(72) Inventors: Varun VARSHNEY, Seattle, WA (US); Donald Frank BRINKMAN, JR., Seattle, WA (US)

(21) Appl. No.: 16/459,101

(22) Filed: Jul. 1, 2019

(51) Int. Cl. G06F 3/0484; G06F 3/0482; G06F 3/0481; G11B 27/00

(52) U.S. Cl. CPC G06F 3/0484; G06F 3/0482; G06F 3/04883; G11B 27/005; G06F 2203/04803; G06F 3/04817

(57) ABSTRACT

Described herein is a user interface and method for playback of a highlight video comprising a plurality of video segments. The user interface has one or more of: 1) an area for displaying playback of video; 2) a plurality of segment sections each representing a corresponding video segment that can be viewed by a user, each segment section being visually separated from other video segments so that a user can visually discern where one segment section ends, and another segment section begins; 3) caption information that describes a currently selected video segment; 4) icons that represent events in a video segment displayed in proximity to the corresponding segment section; and 5) controls that are tailored to allow a user to interact with playback of a video segment, toggle between playback of the entire video containing the segment and the segment itself.

### FIELD

This application relates generally to improvements in user interfaces. More specifically, this application relates to improvements in user interfaces for video players that play segments from one or more videos.

### BACKGROUND

Video players are designed to allow users to view a video in a sequential manner from beginning to end. Controls provided to a user allow the user to play, pause, view the video at full screen and other such manipulations of the video to be played.

It is within this context that the present embodiments arise.

### BRIEF DESCRIPTION OF DRAWINGS

FIG. 1 illustrates an example prior art video player.

FIG. 2 illustrates a representative architecture for configuring a player and engaging playback according to some aspects of the present disclosure.

FIG. 3 illustrates an example of assembling segments according to some aspects of the present disclosure.

FIG. 4 illustrates a representative layered user interface with embedded players according to some aspects of the present disclosure.

FIG. 5 illustrates a representative layered user interface with embedded players according to some aspects of the present disclosure.

FIG. 6 illustrates an example video player user interface according to some aspects of the present disclosure.

FIG. 7 illustrates an example flow diagram for creating captions according to some aspects of the present disclosure.

FIG. 8 illustrates an example flow diagram for creating captions according to some aspects of the present disclosure.

FIG. 9 illustrates an example video player user interface according to some aspects of the present disclosure.

FIG. 10 illustrates an example video player user interface for switching between segment play and full video play according to some aspects of the present disclosure.

FIG. 11 illustrates an example flow diagram for switching between segment play of a highlight video and full video play according to some aspects of the present disclosure.

FIG. 12 illustrates an example video player user interface according to some aspects of the present disclosure.

FIG. 13 illustrates an example video player user interface according to some aspects of the present disclosure.

FIG. 14 illustrates a representative architecture for implementing the systems and other aspects disclosed herein or for executing the methods disclosed herein.

### DETAILED DESCRIPTION

The description that follows includes illustrative systems, methods, user interfaces, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Overview

The following overview is provided to introduce a selection of concepts in a simplified form that are further described below in the Description. This overview is not intended to identify key features or essential features of the claimed subject matter, nor is it intended to be used to limit the scope of the claimed subject matter. Its sole purpose is to present some concepts in a simplified form as a prelude to the more detailed description that is presented later.

A video, by its very nature, is a linear content format, For example, movies are designed to be presented in a serial format, with one scene following another until the entire story is told. Similarly, a sports event captured on video, captures the sequence of events, one after the other, that make up the sports event. However, often a user wants to only see parts of a video. A particular scene, scenes that contain specific characters or dialogue, all the goals in a sports event, only the “exciting” parts of a big game, and so forth

Videos are notoriously difficult to analyze and often it require time-consuming human labor to pick out parts a user might be interested in. Even after such manual effort the result is a single, static set of highlighted moments that does not embody the multitude of combinations that might interest a user.

With the advent of streaming video services, there is more content available online to users than ever before. Some video services are geared toward professionally produced videos such as movies, television programs, and so forth. Other video services are geared toward user generated content such as user produced videos and other such content. Some video services are geared toward particular types of content. For example, as of this writing, twitch.tv has numerous gaming channels where users can stream videos of their gameplay of video games and other activities. Often times, video services allow users or other content creators to post links to other user platforms such as user blogs, websites, and other video content. Thus, video services often drive traffic to other websites along with presenting video content itself.

Many video services provide the ability to embed a video in a 3^{rd}-party website and for wide video control by users either on the 1^{st} party or 3^{rd} party website such as allowing users to seek to a particular location in a video, fast forward, pause, rewind, play video at certain resolutions, select between different audio tracks, turn closed captions on and off, and so forth. The video service provides video content through a local player that sends signals to the video streaming service to adjust the location in the video that should be streamed (e.g., seeking to a particular location in a video, fast forward, rewind, and so forth) and/or adjust other aspects of the delivery. The video service often works with the local player to ensure that sufficient video is buffered on the local side to ensure smooth playback of the video.

U.S. application Ser. No. 16/411,611 (incorporated herein by reference) describes a system that assembles highlight videos comprising video segments drawn from one or more full length videos. The nature of the highlight video makes a prior art video player interface unsuitable for use with such highlight videos. Embodiments of the present disclosure include video player user interfaces that allow a user to effectively interact with a highlight video comprising video segments drawn from one or more full length videos.

In a first aspect, the user interface comprises a main video area where playback of a video segment can be presented.

In a second aspect, the user interface comprises a plurality of segment sections each representing a corresponding video segment that can be viewed by a user as part of the highlight video, each segment section being visually separated from other video segments so that a user can visually discern where one segment section ends, and another segment section begins.

In a third aspect, the user interface comprises a plurality of metadata attributes which the user can independently select and deselect. As a user selects and deselects metadata attributes, a set of metadata attributes is created. In response to the set of metadata attributes being created, the system selects set of video segments, each of which have one or more of the metadata attributes in the set of metadata attributes. The selected set of video segments can be used to create the plurality of segment sections of the second aspect.

In a fourth aspect, the user interface comprises dynamic captions created from metadata attributes from the set of video segments that make up the highlight video. The dynamic captions can be associated with the highlight video, a currently selected video segment, or a combination thereof.

In a fifth aspect, the dynamic captions of the fourth aspect can comprise text, graphic data, icons, other types of data, and/or combinations thereof.

In a sixth aspect, the user interface comprises a sharing control that allows a highlight definition, a link to the highlight video, and/or an identifier to be shared with other users so they can view and interact with the highlight video.

In a seventh aspect, the user interface comprises controls to allow a user to specify the location in the highlight video that should be viewed such as play, stop, seeking to a particular location in a video segment, fast forward, rewind, and so forth, and/or adjust other aspects of the delivery such as playback volume, playback location, size of the video viewing area, resolution of the video segments, and so forth.

In an eighth aspect, the user interface comprises one or more controls that allows playback of one of the full length videos from which a video segment is drawn.

In a ninth aspect, the user interface comprises one or more controls that allows a user to return from a full length video to the highlight video.

In a tenth aspect, the user interface presents additional information that is contextual to a control over which a user is hovering.

In an eleventh aspect, icons representing events are displayed in proximity to the segment sections of the second aspect.

Embodiments of the present disclosure can comprise any of the above aspects (e.g., 1-11) either alone or in any combination.

Description

### Prior Art Video Player User Interfaces

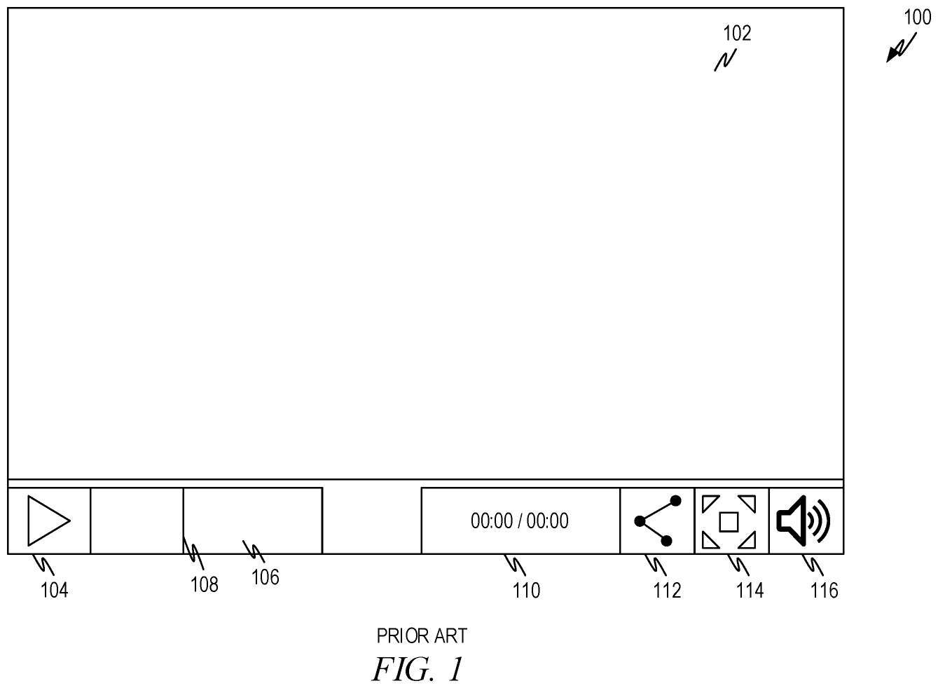

FIG. 1 illustrates an example 100 of a prior art video player and its user interface. The user interface of the prior art video player has been created to allow a user to interact with the liner nature of a single video that is played in the video player. For example, the video player user interface comprises a viewing area 102 where the video playback can be displayed. The user interface also comprises a play control 104 that initiates playback of the video. When the video is being played, the play control 104 can be changed to a pause and/or stop control to pause and/or stop playback of the video, respectively.

The user interface may also comprise a progress/scrubbing bar 106 with the relative location of the playback being indicated by a position indicator 108. This allows the user to see where they are in the video. In some instances, the user may be able to activate the position indicator to scrub forward and/or backward in the video to seek to a new location. In some instances, the user interface may comprise a playback time indicator 110 that shows the current time mark of the position indicator 108 and/or the total length of the video.

Some user interfaces comprise a sharing control 112 that allows a user to share the video with other users.

Some user interfaces comprise one or more controls 114 that allows a. user to adjust the playback area (e.g., viewing playback at full screen or in a windowed manner) and/or playback resolution.

Sonic user interfaces comprise a control 116 that allows the user to mute the playback volume or adjust the volume of the playback volume.

Some prior art video players have more or fewer controls. However, all the controls of a video player are designed to allow a user to interact with a single video designed to play in a linear fashion. Such a video player user interface is not suited to playing a highlight video which comprises a plurality of segments drawn from one or more underlying full length videos.

### Highlight Video Service Architecture

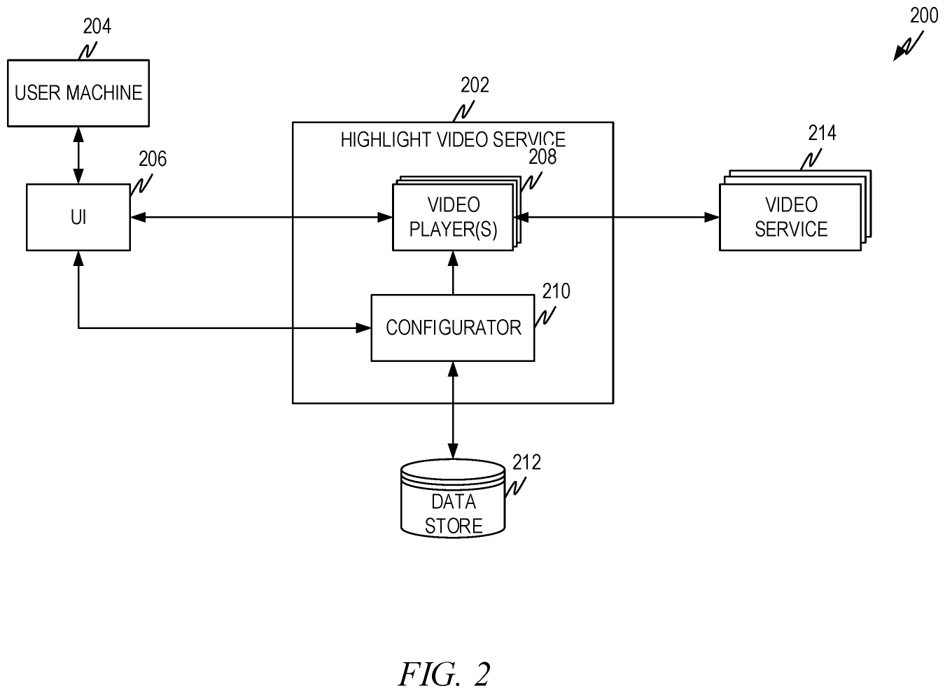

FIG. 2 illustrates a representative architecture 200 for configuring a player and engaging playback of a highlight video according to some aspects of the present disclosure. Such an architecture can be provided by, for example, embodiments disclosed in U.S. application Ser. No. 16/411,611, which is incorporated herein by reference.

A highlight video service, also referred to as a summary service, 202 comprises a configurator 210, one or more video players 208, and has access to a data store 212, which stores one or more of collected metadata, aggregated metadata, and/or highlight video definitions.

A user interacts with the highlight video service 202 through a user machine 204 and an associated user interface 206, which can be a user interface as described herein. Although the highlight video service 202 is shown as separate from the user machine 204, some or all of the aspects of the highlight video service 202 can reside on the user machine 204. For example, the configurator 210, video player(s) 208, and/or the data store 212 can reside on the user machine 204, on a server, and/or on other machines in any combination. The highlight video service 202 would comprise the remainder of the aspects and/or methods to allow the user machine aspects to interact with the highlight video service 202.

The user interface 206 can allow the user to create a highlight video definition, to playback a highlight video, to select a highlight video definition for playback, to manipulate/edit previously created highlight video definitions, and otherwise interact with the highlight video service 202 and/or video service 214.

The user can select, define, create, or otherwise identify a plurality of video segments for playback (e.g., a video segment playlist). These can be contained in a highlight video definition and/or other data structure. The video segment playlist, the highlight video definition, and/or other data structure is presented to the configurator 510. If the data structure presented contains only a query definition, the configurator 510, or another aspect, uses the query definition to create a segment playlist by retrieving segments and/or segment identities using the query and/or other information. The segment playlist comprises information that:
Identifies each segment that has one or more selected metadata attributes and that is to be played as part of the highlight video, including how and where each segment can be accessed. For example, name and/or location (e.g., URI) of the video containing the segment, the segment start time, and the segment length and/or stop time so re system knows when the segment ends.
Identifies the play order of the segment.
If multiple players are to be displayed simultaneously (see below), information that shows how segments that should be played simultaneously should be synchronized relative to each other.

Note that the segment playlist is different from a playlist that is associated with a movie or other such video. In some instances, a longer movie and/or other video is divided into “Chapters” which represent a location in the longer movie that a user can seek to and begin playback. Some forms of copyright protection keep one or more lists that allow the video player to reconstruct the longer movie by playing “sections” of the movie in a particular order. However, the segment playlist above is different from both a chapter list and a section playlist.

The chapter list is different from the segment playlist in that the chapter list simply represents a list of positions within the longer movie. The segment playlist, on the other hand represents a subset of segments drawn from one or more longer videos that are arranged to be played in a particular order.

The section playlist is different from the segment playlist in that the section playlist reconstructs the entire movie. The segment playlist, on the other hand represents a subset of segments drawn from one or more longer videos that are arranged to be played in a particular order. The segments are selected based on the content of the segment and not based on the play order of the segment.

During playback, the configurator 210 configures one or more video players 508 to playback the desired video segments in the desired order. This can include, passing to the player 508 information to access the video containing the segment to be played, the location within the video where playback should start (e.g., the segment start time) and where playback should stop (e.g., the segment stop time). If the players 208 do not have such capability, the configurator can monitor the playback and when playback reaches the segment reaches the end point, the configurator 210 can signal that playback should stop and configure the player to play the next segment in the segment playlist. If the players 208 have the capability, the configurator 210 can configure multiple segments at once.

The video players 208 interact with the video service 214 to access and play the current video segment. The video player 508 will access the video service 514 and request streaming of the first video starting at the location of the first video segment. The video player 208 will begin streaming the video at the specified location. When the video playback reaches the end of the segment, the video player 208 (or the video player 208 in conjunction with the configurator 210 as described) will request the video service 214 begin to stream the next video at the starting location of the next video segment. This continues until all video segments have been played in the desired order.

Highlight video definitions can be stored for later use. Thus, there can be a time difference between when the highlight video definition is created and when the definition is utilized to perform playback of the series of video segments that make up the highlight video. Additionally, at least in some embodiments, the highlight video definition can contain a segment playlist as previously described. At the time the segment playlist was assembled into the highlight video definition, or at least when the metadata was aggregated, all segments were accessible and available at the appropriate video services. However, because of the time difference between when the video playlist was created (and/or when the metadata was collected and/or aggregated), there is the possibility that one or more of the video segments are no longer accessible at the video service(s) 214 at the time of playback.

Because of this issue, embodiments of the present disclosure can be programmed to handle missing and/or unavailable video segments. This can be accomplished in various ways. If the highlight video definition comprises the query definition, the segment playlist can be created/recreated and used. Another way that segment availability can be checked is that prior to initiating playback, the configurator 210 can attempt to access the video segments in the playlist either directly or through a properly configured video player 208. If an access error occurs, the configurator 210 can adjust the playlist and, in some embodiments update any playlist stored in the highlight video definition. In still another way, segment availability is not checked prior to initiating playback of the highlight video definition. Rather the configurator uses multiple embedded players such that as one segment is being played a second player is configured to access the next segment on the list without presenting any video content of the second player to the user. If an error occurs, the configurator 210 can skip that segment and adjust the segment playlist in the highlight video definition, if desired. In this way, the segments are checked just prior to when they will be played and on the fly adjustments can be made. Any one approach or any combination of these approaches can be used in any embodiments described herein.

During playback of a highlight video segment, either as part of playing of an entire highlight video or from viewing a segment in some other context, users can provide adjustments to metadata and/or feedback as part of the viewing experience. Thus, when the video from video players 208 is presented, the UI 206 can allow users to make adjustments to metadata, control playback, and/or provide feedback. In some instances, the user interface can present selection options allowing a user to provide specific points of feedback or changes clip is exciting or not exciting). In other instances, fields where a user can enter freeform information can be provided (e.g., entry field for a new title). In still other instances a combination of these approaches can be used.

The user input can be provided to the configurator 210 and/or another aspect of the highlight video service 202 in order to capture the adjustments to metadata and/or feedback. As described herein, the adjustments to metadata can comprise adding new metadata, removing existing metadata, and/or modifying metadata. As described herein, the adjustments and/or feedback can be used to adjust stored metadata, can be used to annotate metadata for training models, and/or any combination thereof. Conditions can be attached so that the feedback and/or adjustments are not used or are only used for some purposes but not others until one or more conditions are achieved.

The highlight video service 202 can be used in conjunction with other services. For example, highlight video service 202 can work in conjunction with a search service to serve example clips that are relevant to a user's search query. In a representative example, the user's search query and/or other information from the search service is used to search the data store 212 for clips relevant to the search query. The searching can be done by the search service, by the configurator 210, and/or by another system and/or service. The clips can be ranked by the same methods applied by the search system to identify the top N results of the clips.

One or more video player(s) 208 can be embedded into the search results page, either as part of the search results, in a separate area of the search results page, in a separate tab in the search results, and/or so forth. Metadata can also be presented in proximity to the embedded video players to describe the clips that will be played by the embedded players. The players can then be configured to play the corresponding video clip by the configurator 210 or similar configurator associated with embedded players of the results page. The players can then initiate playback of a corresponding video clip on an event such as the user hovering over a particular player, selection of a particular player, and/or so forth.

### Video Segment Play Order

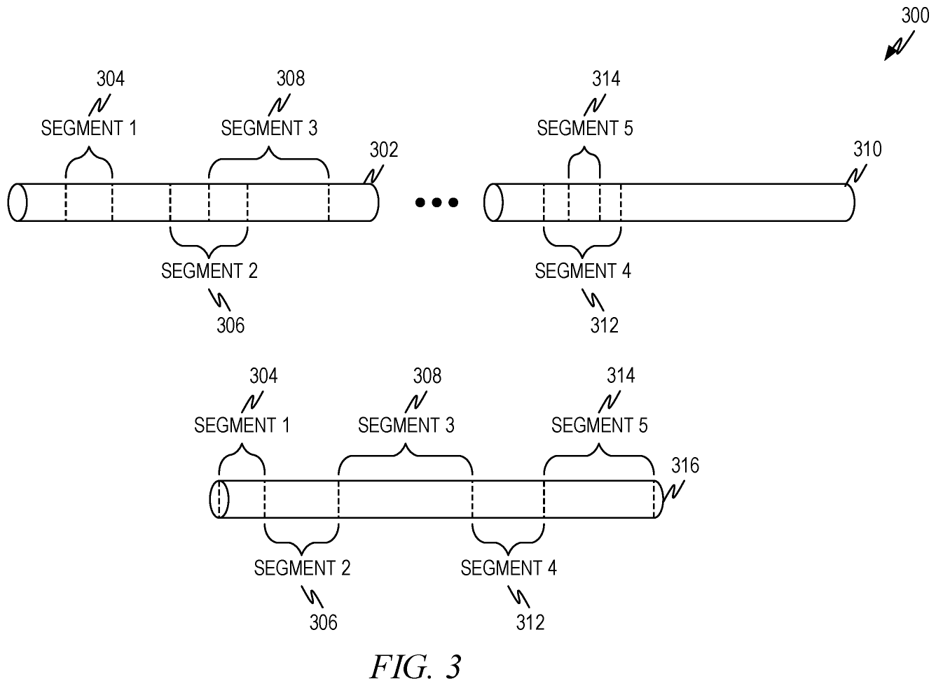

Once the video segments that will make up the segment playlist are identified, a segment play order is created. FIG. 3 illustrates an example 300 of assembling segments according to some aspects of the present disclosure. Video 302 and video 310 represent underlying videos from which five different video segments, labeled segment I through segment 5, are drawn. As discussed herein, the video segments that form a highlight video can be drawn from one or more underlying full length videos. Video 302 and video 310 represent such full length videos,

When there is no overlap between video segments in a single video 302, the segment order is easy to determine. In such a situation, it often makes sense to simply present the segments in the order that they occur in the video.

However, when the video segments overlap, determining an appropriate video order can be more complicated. FIG. 3 illustrates different forms of segment overlap. Thus, segment 5 314 is fully contained within segment 4 312, in that the start time for segment 5 314 Occurs after the start time of segment 4 312 and the end time of segment 5 314 occurs before the stop time of segment 4 312. Segment 2 306 and segment 3 308 show an overlap pattern where the start time of segment 3 308 occurs after the start time of segment 2 306, but the end time of segment 3 308 occurs after the end time of segment 2 306, Finally, segment 1 304 does not overlap with any other segment.

One approach to such overlapping segments is to use a single video player and sort the segments into a play order using an attribute of the segments. For example, the segments can be sorted by start time and played in start time order. This is illustrated in FIG. 3 where the start times of segment 1-segment 5 occur in the order of start time, starting with the first video 302 and then moving on to the second video 310. Thus, the segments are sorted first by video, and then by start. time. Thus, the resultant play order is segment 1 304, segment 2 306, segment 3 308, segment 4 312, and segment 5 314. Thus, the segments are ordered according to start time without regard to any overlapping material and played in start time order, one after the other after the segments have first been ordered by video. Ordering by any other metadata attribute is also possible, For example, stop time order or any other attribute could also be used. Such an ordering can be made by first ordering the segments by video and then by one or more metadata attributes, or by ordering by one or more metadata attributes without regard to which video they come from. In the ordering process, which video the segments are drawn from is simply another metadata attribute that can be used in ordering, if desired.

A second approach to overlapping material can be used. Multiple players can be used to play the segments in a synchronized manner according to one or more segment attributes. For example, time-synchronized according to start time. Thus, because there are at most two overlapping segments in this example, two players are used. The two players are synchronized to show the same video during periods of overlap. Thus, the first player would begin to play segment 1 304. As the start time for segment 4 312 arrives, segment 4 begins playing in a synchronized manner on the second player. The synchronized play would continue until the end time of segment 1, after which the segment 1 playback would be stopped on the first player.

This would continue by playing the segments on the appropriate player as the start time for the segment arrives. This continues until the last segment is played.

In this second approach, multiple players allow for separate identification (which segment is playing), annotation using segment metadata or other captioning (see below), and/or so forth of the different overlapping segments.

### Multi-Layered Player Interface

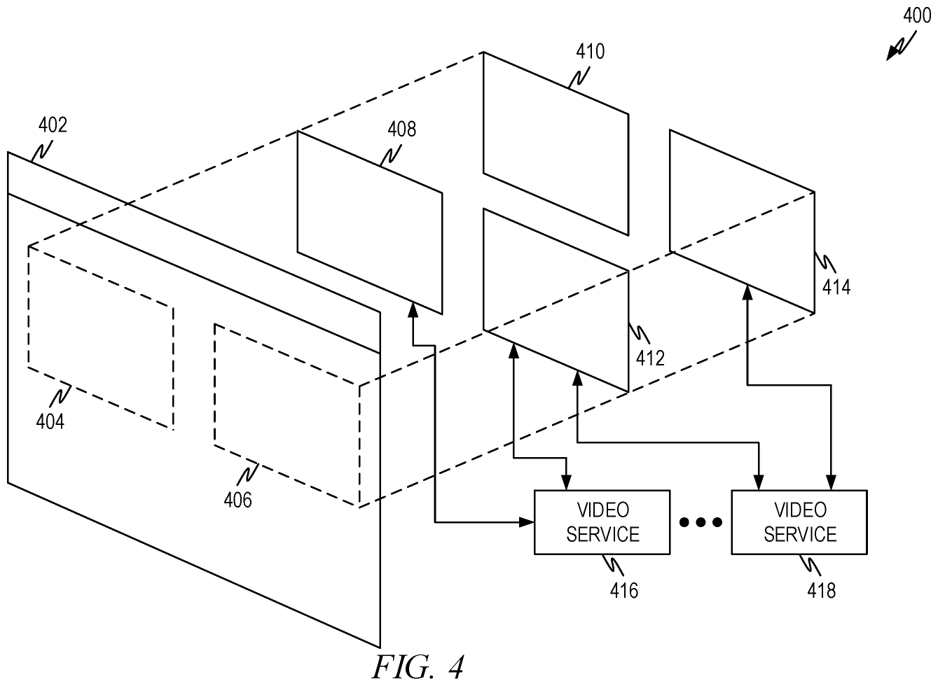

FIG. 4 illustrates a representative 400 layered user interface with video players according to some aspects of the present disclosure. in this embodiment, the user interface 402 used to present video segments of a highlight video to the user can comprise one or more players 408, 410, 412, 414 that present video in one or more regions 404, 406 of a user interface 402. it is commonly known that user interfaces can have multiple stacked layers that overlay one another in a “z” direction on a display device (i.e., normal to the display on the device). These different layers are presented through a “top” layer 402. Content in any particular layer can be made visible by revealing and hiding areas of intervening layers. For example, if the content from player 408 is to be presented in area 404 of the user interface 402, the area 404 can be made transparent or “invisible” so that the “visible” area in the layer with player 408 is revealed. Similarly, the content from player 410 can be made my making the area 404 and player 408 invisible or transparent.

Rather than making areas transparent and non-transparent, the content from one layer can be moved from one layer to another so it is on “top” of content from other layers. Thus, revealing the content from player 410 may be implemented by bringing player 410 from the “back” layer to the “top” layer, so that it hides content from the other layers. As yet another examples, the layers can be reordered so that layers are moved to the “top” when content in that layer should be visible. Layers can be of different sizes so that reordering layers does not (or does, depending on the relative size of the layers) fully hide all the information in lower layers.

The specifics of how revealing content from one layer and hiding content from other layers is implemented often depends on the particularities of the operating system, the application, or both. However, with this description, those of skill in the art will understand how to utilize the implementation of the particular operating system and/or application to implement the hiding and revealing behavior that is described herein.

The multiple players stacked behind one another and/or side by side can help remove or mitigate buffering and/or download issues. Additionally, the multiple players can be used to test availability of video segments as previously described.

Suppose a single video has multiple segments that are to be shown. Two different players 412, 414 can connect to the video service 418 where the video resides. One player 412 can queue up the first video segment and the other player 414 can queue up the second video segment. Thus, the output of the first video player 412 can be revealed in the user interface 402 and the first video segment played. While that occurs, the second video player 414 can queue up the second video segment. When the first video segment finishes, the output of the second video player 414 can be revealed in the user interface 402 while the output of the first video player 412 is hidden. The second video segment can be played while another video segment, either from the same video service 418 or a different video service 416 is queued up for playing on the first video player 412 after the second video segment is finished (e.g., by revealing the output of the first video player 412 and hiding the output of the second video player 414). This can continue, going back and forth between the video players, alternatively showing and hiding their output until all segments in the segment playlist are presented and played. In this way, the buffering and/or setup delays can be removed or lowered by taking place while the previous segment is being played.

Multiple players can also be used where both of their output can be presented in different areas of the user interface 404, 406. Thus, rather than switching players in “depth,” players can be switched in “breadth.” Furthermore, multiple combinations thereof can be used. Thus, two players with the ability to present simultaneous output (e.g., in areas 404 and 406) can be used to present simultaneous segments such as discussed herein. Additionally, the multiple “depth” players can be used to reduce or eliminate perceived delays with buffering and so forth as explained above.

The configurator of the service (or another method) can be used to implement video player switching as described.

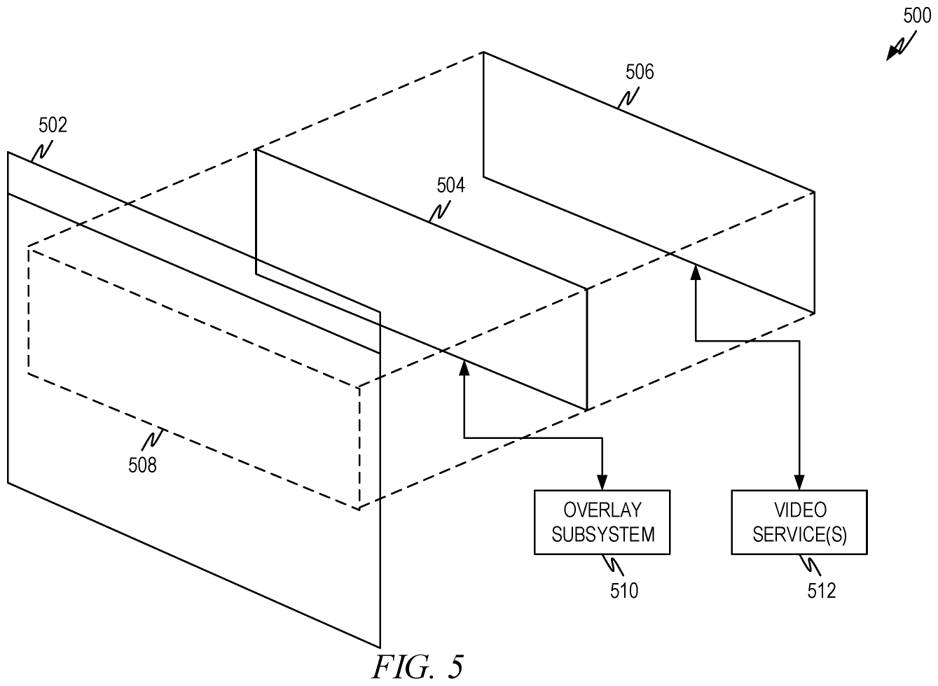

FIG. 5 illustrates a representative 500 layered user interface with video players according to some aspects of the present disclosure. In this representation, layer 506 can represent a single video player or the multiple layers, multiple video players as described in FIG. 4. The user interfaces for video players of the present disclosure can be implemented natively to the video player(s) (e.g., 506) or can be implemented as one or more overlays 504 or a combination thereof.

As a representative example, consider that a video player 506 developed to interact with particular video service(s) 512 comprises the prior art user interface of FIG. 1. As discussed herein, the prior art user interface is unsuitable for many of the functions to easily interact with a highlight video comprising a plurality of video segments drawn from one or more underlying video players. In one aspect, the user interfaces of the present disclosure can be implemented by implementing the disclosed user interfaces on one or more overlays 504 so that some or all of the controls of the prior art user interface (e.g., FIG. 1) are replaced by other controls that function as described herein. User gestures and/or commands can be intercepted by the overlay 504 and/or overlay subsystem 510 and the underlying functionality implemented as described herein by the overlay subsystem 510, by the system issuing commands to the underlying video player 506 and/or the video service(s) 512, and/or by system functionality in the highlight video service.

It is known how to “hook” events and/or otherwise intercept user input (e.g., gestures and/or commands) before it reaches the video player 506. How this is done is dependent upon the underlying user interface infrastructure, but all have functionality that will allow those of skill in the art to implement an overlay that intercepts some or all of the user gestures and/or commands and implements functionality for different user interface controls as described herein.

The overlay may completely replace the existing controls of the video player user interface. As an alternative, only some of the existing controls may be “covered up” and replaced.

Of course, the user interfaces of the present disclosure can be implemented without overlays and simply be “native” to the video players used to play a highlight video.

### Highlight Video Player User Interfaces

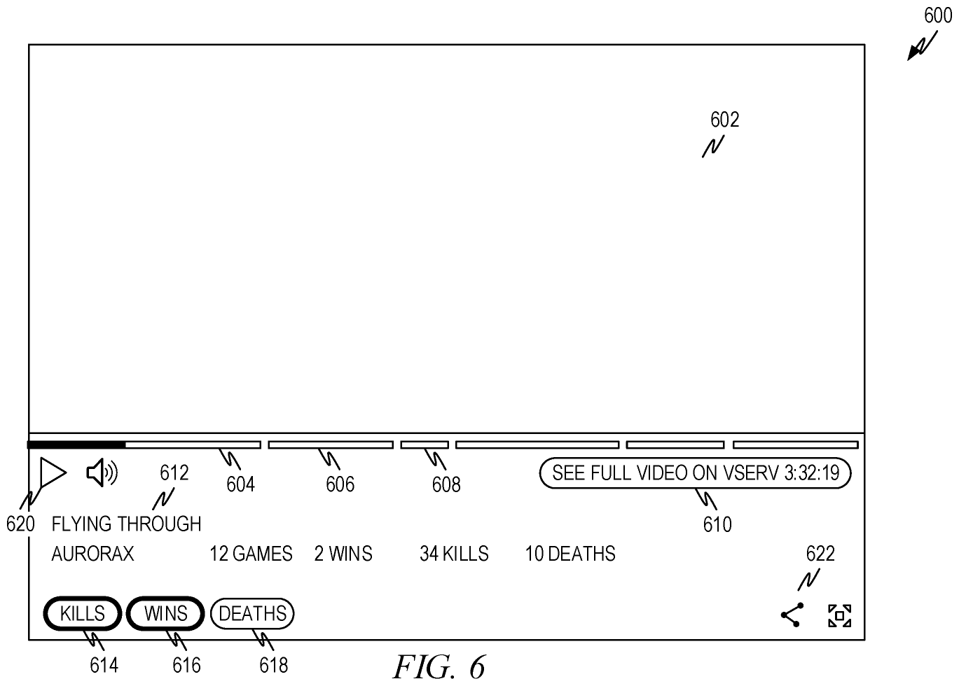

FIG. 6 illustrates an example 600 video player user interface according to some aspects of the present disclosure. The video player user interface has a region 602 where playback of a currently selected video segment is displayed.

Existing progress bars that show the playback progress of a video are not well suited to playback of a set of video segments in a highlight video, particularly as the video segments of the highlight video are not likely to be contiguous. Thus, user interfaces according to the present disclosure can comprise a plurality of segment sections (e.g., 604, 606, 608) each representing a corresponding video segment that can be viewed by a user, each segment section can be visually separated from other video segments so that a user can visually discern where one segment section ends, and another segment section begins. In FIG. 6, the segments sections 604, 606, 608 are discrete segments separated from other segments by a gap. However, other mechanisms can be used to visually separate one segment section from another. For example, bars, lines, shading, color, and so forth can be used to visually separate one segment section from another.

The segment sections 604, 606, 608 are shown in a manner where the relative length indicates the relevant length of the corresponding segment. Thus, the video segment corresponding to segment section 604 is significantly longer than the video segment corresponding to segment section 608. The relative segment length can be determined by considering the total play time (e.g., hours, minutes, seconds) of all the segments compared to the play time of the video segment whose corresponding segment length is to be determined. 100811 As the player progresses in playing a particular video segment, the corresponding segment section can be shaded, a bar placed, and/or other indicators can be used to show the playback progress. As a representative example, the segment section 604 shows darker shading to indicate playback progress.

User interfaces according to some embodiments of the present disclosure can also use dynamic captioning to convey information about the highlight videos and/or a currently playing (or currently selected) video segment. Thus, the embodiment of FIG. 6 includes dynamic captioning 612. In this particular example, the dynamic captioning is shown as text, but icons, graphics, and/or any other form can be used as dynamic captioning. In this particular example, the dynamic captioning includes the title of the video from which the currently playing segment is from (e.g., “Flying Through”), the person posting the video or the content creator “Aurorax”) and information about the events that may be of interest in the full length video (e.g., the underling video contains “12 Games,” “2 Wins,” “34 Kills,” and “10 Deaths”).

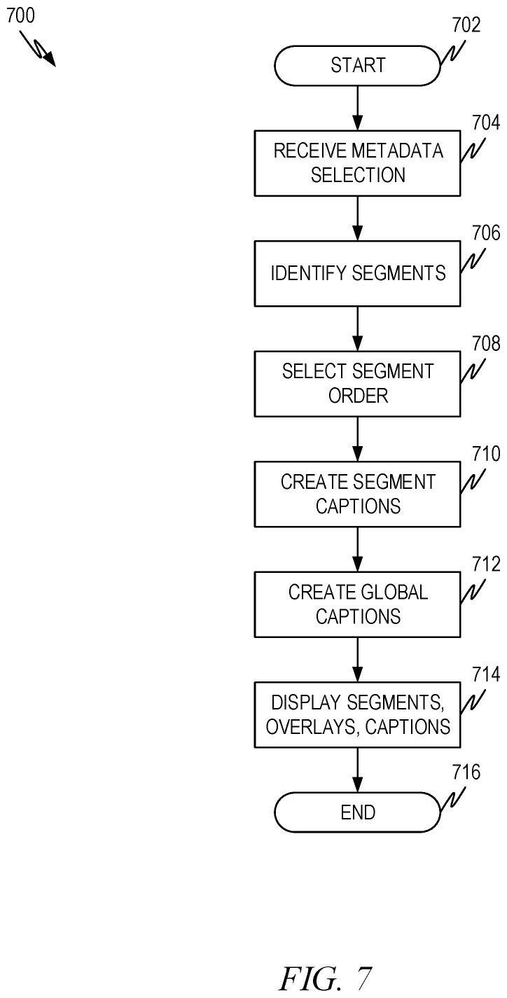

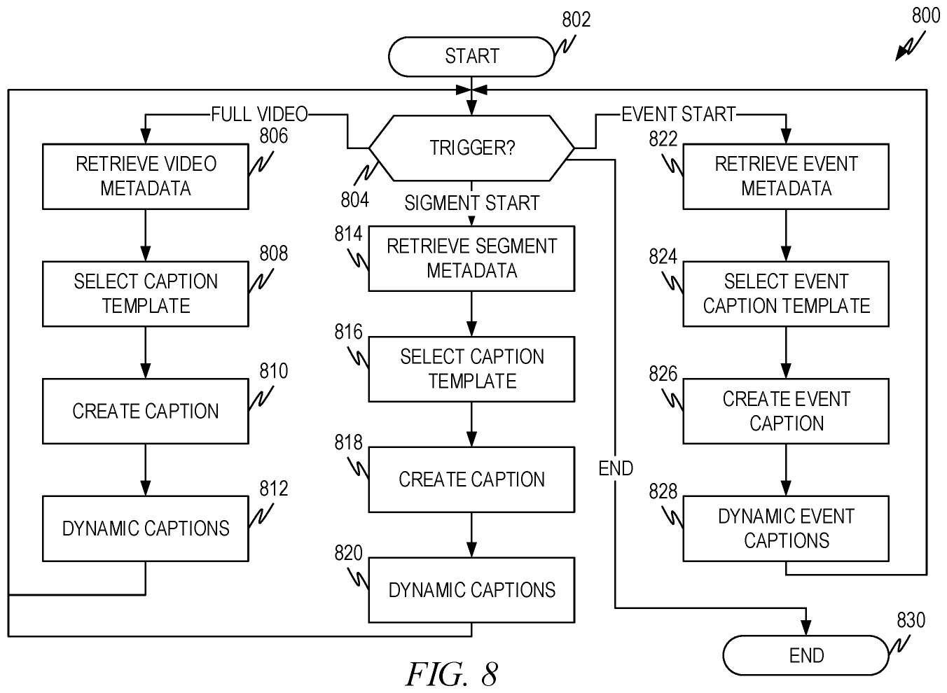

FIGS. 7 and 8 discuss dynamic captioning in greater detail and other figures show other forms of dynamic captioning that can be used.

User interfaces according to embodiments of the present disclosure can also comprise a plurality of metadata attributes that can be used to select video segments to be part of the highlight video. The highlight video of FIG. 6 presents a highlight of one or more videos that depict playing of video games. Thus, the metadata attributes in this context can be events that people may be interested in seeing, such as kills 614, wins 616, and deaths 618. The metadata attributes that are displayed can be any metadata attributes that a user can utilize to select desired video segments and that represent events that occur in a video segment. Thus, if a user wishes to see only “wins,” the user could select the wins 616 control and the system will select only segments that include wins.

The metadata attributes can be displayed on the main user interlace, or can be displayed in a pop-up, child window, or in some other fashion.

The metadata attributes (e.g., kills, wins, deaths) can have specific properties associated with them if desired. In the example of FIG. 6, the user has selected the kills 614 attribute and the wins 616 attribute. Thus, the video segments that are part of this highlight video comprise at least one of those attributes. The video segments that are selected can meet some threshold, such as N kills in S seconds or some other selection criteria. Such selection criteria can be adjusted by a user in some embodiments. In other embodiments, the system sets the selection. In still other embodiments, there are no additional selection criteria associated with the metadata attributes that are displayed. U.S. application Ser. No. 16/411,611 contains more details on how segments are selected using one or more selected metadata attributes.

As the user selects and/or deselects the metadata attributes, the video segments that make up the highlight video are added, removed, and/or otherwise adjusted. Thus, selecting and/or deselecting attributes can cause the number of segment sections to also be adjusted.

Embodiments of the present disclosure can also comprise a control that allows the player to switch between playing the current segment and the full underlying video. Thus, the user can activate control 610 to pause playback of the current segment and initiate playback of the full underlying video (e.g., the video from which the current segment is taken). This process is discussed in greater detail below. In this particular implementation of the control 610, the control shows that the full underlying video is accessed on the video service “VServ” and has a run time of 3:32:19. Other information or ways of displaying the information can be used. Selection of the control 610 will initiate playback of the full underlying video as discussed below.

Embodiments of the present disclosure can have controls that allow playback, pause, fast forward, and so forth of the video segments. For example, control 620 can initiate playback of the currently selected segment. Other controls such as are known in the art can also be used.

Some controls can operate the same as is known (such as play, pause, stop, and so forth) and some controls can operate differently. For example, control 622 is familiar and allows sharing of the video. However, this control operates differently than in the prior art. In the prior art, hitting the sharing control typically produces a link to a video that the user can share with others and that will play the video when the link is activated. However, highlight videos are not an actual video as such. As explained in U.S. application Ser. No. 16/411,611, and as discussed above, highlight videos are defined by a collection of metadata attributes that describe what video segments make up the highlight video, a play order for the video segments, where/how the video segments can be accessed, and/or other metadata. Thus, the sharing control 622 typically does not produce a link to a video, but rather a link that either encodes the appropriate metadata attributes that describes the highlight video or a link where a highlight video definition can be retrieved. The link can also include information that allows a highlight video service (e.g., 202) to be accessed, points to where an appropriate video player can be obtained and/or instantiated, and/or so forth. The highlight video service, video player, and so forth can be given the appropriate (e.g., encoded, linked, and so forth) metadata attributes so that the highlight video can be recreated.

The system can also keep track of modifications made to the highlight video (e.g., modifications to the metadata that defines the highlight video) so that others can see the different versions created by the user. Thus, a versioning system, a log, and/or other mechanism can be used to keep track of such changes and allow users to retrieve and/or recreate any particular version

FIG. 7 illustrates an example flow diagram 700 for creating captions according to some aspects of the present disclosure. The method begins at operation 702 and proceeds to operation 704 where the metadata selections are received. These are the metadata properties that describe the highlight video and includes, for example, which video segments should be selected for the highlight video. For example, the metadata can comprise the metadata. properties that are part of the user interface (e.g., 614, 616, 618) that have been selected by the user. Other metadata properties can also be used, for example draw highlights from all the games that Manchester United played as part of the 2017 season, all videos whose content creator was Blaster871 and that have a creation date in June of 2019. The metadata can be obtained from the user via the user interface, can be obtained by a highlight video description as discussed in U.S. application Ser. No. 16/411,611, can be obtained from an encoded URL, and/or any combination thereof.

Operation 706 identifies the segments that make up the highlight video based on the metadata obtained on operation 704. For example, the metadata from operation 704 can comprise a segment list, can comprise a set of search parameters, on in any other way can specify what video segments should be selected. In some embodiments this may entail searching a database of metadata that correlates metadata attributes (e.g., such as 614, 616, 618) and/or search parameters to video segments, the underlying full length video, and where the segments can be obtained and/or located, such as described in U.S. application Ser. No. 16/411,611.

Operation 708 identifies a segment play order. As discussed herein, segment play order can use one or more metadata. attributes associated with the video segments. For example, the video segments can be ordered first by full length video and then by start time, As another example, the video segments can be ordered by start time without regard to what full length video they are drawn from. As another example, the video segments can be ordered by events that occur in the video segment (e.g., kills, wins, deaths, etc.). Any metadata and/or combination thereof can be used to order video segments.

Operation 710 creates segment captions, if any, operation 712 creates global captions, if any, and the segments and/or captions are displayed in operation 714. Operation 710 is discussed in greater detail in FIG. 8. At the end of playback, the method ends at operation 716.

FIG. 8 illustrates an example flow diagram 800 for creating captions according to some aspects of the present disclosure. The method begins at operation 802 and proceeds to operation 804 which waits until a trigger occurs. A trigger in this sense is an event or other occurrence that triggers dynamic captioning. In FIG. 6, text captions are used and conic in two different types. A first type is a whole video caption and the second is a caption for the segment and/or for all segments. For example, “Flying Through” and “Aurorax” may be dynamic captions associated with the underlying full length video that describe the title of the video and the video content creator (e.g., the user that streams the video, or other content creator or owner). The caption “12 Games, 2 Wins, 34 Kills, and 10 Deaths,” may describe the total number of events for all the segments in the highlight video. The other UI figures show different examples of different types of dynamic captioning that may be used.

In FIG. 8 four triggers are shown, but any number of triggers for different types of dynamic captioning can be used. The three types of dynamic captioning that are shown in FIG. 8 are dynamic captioning based on information from the underlying full length video, dynamic captioning based on information from the current video segment, and dynamic captioning based on an event occurring in the current video segment.

The system waits in operation 804 until one of the four triggers occurs. When the player begins playing a segment from a new underlying full length video, the full video trigger occurs and execution proceeds to operation 806 where metadata that will be used to create the dynamic captioning for the full length video is retrieved. For example, the title of the full length video, a short summary of the full length video, a content creator and/or owner, and so forth may be used in dynamic captioning.

In operation 808 an appropriate caption template is retrieved. The caption template can comprise fixed text and dynamic text. The fixed text is, as the name implies, fixed for the template and the dynamic text are placeholders that are filled using the metadata retrieved in operation 806. For example, the template may be “Title: <videoTitle>” along with any formatting information to be used to format the dynamic caption. The placeholder “<videoTitle>” would be replaced by the full length video title as specified in the metadata.

Operation 810 creates the dynamic caption by making the appropriate substitution of placeholders with information from the associated metadata.

Operation 812 displays the resultant dynamic caption. Dynamic captions can be displayed in an overlay, as part of the user interface itself, or any combination thereof.

While the above has been described using a single template, multiple templates can be used, such as a template for the title, a template for a short summary, a template for the content owner, and so forth. As an alternative, a single template may have multiple metadata placeholders. So a single template could have places for the title, short summary, content owner, and so forth.

When a new segment begins to play and/or is selected, the “segment start” trigger occurs and operations 814-820 are performed. These operate, mutatis mutandis, as operations 806-812 are described. Segment metadata that can be used for dynamic captioning includes, but is not limited to, segment length, events (number of kills, deaths, etc.) that occur in the segment, and/or other metadata as described herein.

When a new event occurs within a video segment, the “event start” trigger occurs and operations 822-828 are performed. As discussed herein, a single video segment can have multiple events in the segment. Thus, a single video segment that is drawn from a full length video of a baseball game may have a hit and sometime later may have a run. Thus, as the hit and then the run in the video segment occur, dynamic captioning may modify the captions on a per event basis. This is what is described in operations 822-828. These operate, mutatis mutandis, as operations 806-812 are described.

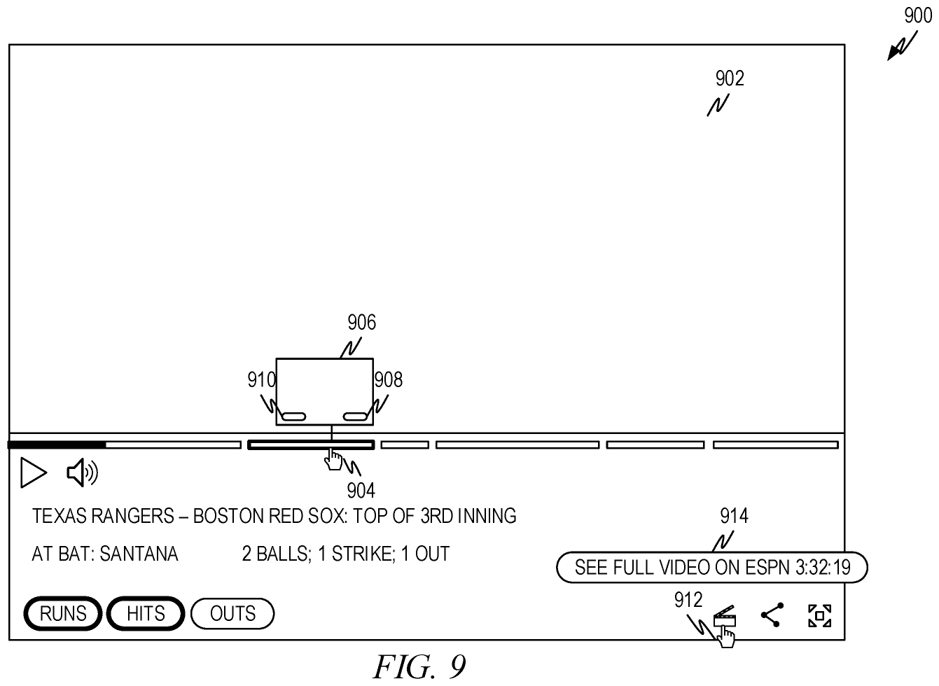

FIG. 9 illustrates an example video player user interface 900 according to some aspects of the present disclosure. The video player user interface 900 can share similar features to other video player user interfaces described herein such as a region 602 Where playback of a currently selected video segment is displayed, controls that allow playback/pause, adjustment of the volume, sharing, viewing at a different resolution and/or size, controls to allow a user to select/deselect metadata attributes, and so forth. All these can operate as described herein,

FIG. 9 also shows some of the user interface and player behavior upon a hover gesture or command and/or a selection command. A hover command can be triggered by a user placing a pointer/cursor over a control for a period of time, by a touch for a period of time (e.g., such as a long press) and/or in other ways.

A user can hover over and/or select a segment 904. Upon receiving the command/gesture, a pop up window 906 can be displayed. A frame, live preview, and/or so forth can be displayed in the popup window 906 to give the user more information about the video segment associated with the display segment 904. In one embodiment, the frame and/or live preview can be drawn from the relative location of the pointer within the display segment 904. Thus, the frame and/or preview is drawn from the corresponding video segment from a location that corresponds to the relative location of the pointer within the display segment 904. As the user scrubs back and forth in the display segment 904, the video preview and/or frame displayed in window 906 can be changed. In another embodiment, the frame and/or live preview can be selected from the corresponding video segment without regard to the relative location of the pointer within the display segment 904.

If the user the selects the display segment 904, the video segment can begin playing. The start of the playback in some embodiments can be the location within the video segment that corresponds to the relative location of the pointer within the display segment 904. in other embodiments, playback can begin at the start of the video segment. in still other embodiments, a select command and/or gesture may begin playback of the underlying full length video, at the location of the corresponding video segment (either the start and/or the relative location of the pointer within the display segment 904). In still other embodiments, in select command and/or gesture (single click, short press, etc.) may begin playback of the video segment while another type of select command and/or gesture (double click, long press, etc.) may begin playback of the underling full length video.

In the embodiment of FIG. 9, a “full length” video control 912 is included. This video control is represented by an icon, rather than the text of 610. When the control 912 is selected, the system can begin playback of the underlying full length video of a selected video segment, such as a segment being currently played or a segment 904 that is otherwise selected.

When a user hovers over video control 912, information 914 about the underlying full length video can be displayed. Thus, a hover may display the video service where the video can be found (e.g., ESPN), the length of the full length video (e.g., 3:32:19), and what happens if the user clicks or otherwise activates the control 912 (e.g., the full video will begin to play).

The dynamic captioning of the user interface comprises underlying full length video information (e.g., Texas Rangers vs. Boston Red Sox), segment information (e.g., top of 3^{rd} inning, and Santana at bat), and event information (the current count, 2 Balls, 1 Strike, 1 Out). As further events occur (e.g., the count changes), the dynamic captioning can be updated.

Additionally, the metadata attributes for the available segments (Runs, Flits, Outs) are displayed with the currently selected metadata attributes highlighted, displayed in a different color, etc. (Runs, Hits).

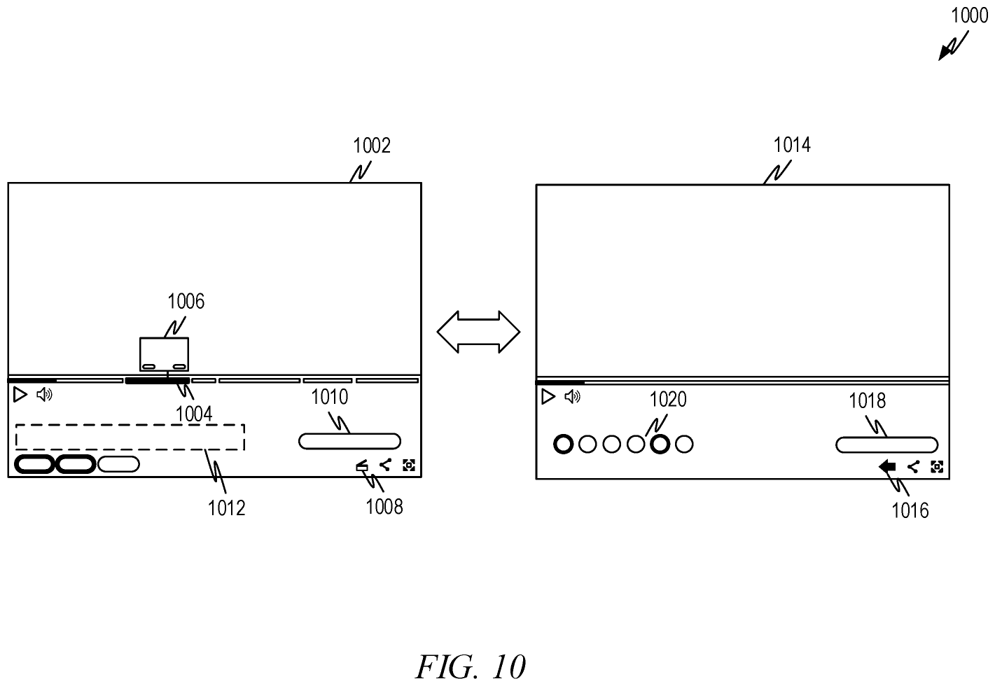

FIG. 10 illustrates an example video player user interface 1000 for switching between segment play and full video play according to some aspects of the present disclosure. As discussed herein a highlight video user interface can comprise one or more mechanisms for initiating playback of the underlying full length video. Thus, the user can play a video segment from the underlying full length video, for example by selecting the video segment, pressing the playback control (e.g., 620), and so forth. The user can also initiate playback of the underlying full length video by activating a different control, such as double clicking a segment (e.g., segment 904) and/or activating a control that initiates playback of the underlying full length video for a selected video segment (e.g., 912, 610).

Thus, in the highlight video user interface 1002, the use can double click on segment 1004. click on control 1010 and/or 1008, and so forth. Dynamic captioning for the underling full length video for a segment of the highlight video 1012 can also be selected in some embodiments to initiate playback of the underlying full length video associated with a video segment.

In some situations, playback of the full length video can occur beginning at the selected video segment, while in others, playback can occur at the beginning of the full length video.

Once playback of the full length video is initiated, a user interface 1014 tailored to playback of a full length video rather than the user interface tailored to the highlight video can be displayed. Thus, the controls available, dynamic captioning, and so forth can be customized for the full length vide rather than the highlight video.

Thus, user interface 1014 can have dynamic captioning 1020 that describes the full length video and/or what is currently happening in the video. Additionally, information 1018 such as the current playback location, an indication that the full length video is being played, and so forth can be displayed.

However, since playback of the full length video was initiated from the highlight video, the user interface 1014 can comprise a control 1016 that when activated returns to the highlight video and its user interface 1002. In this way, playback of the full length video can be paused and/or terminated, and the user returned to the highlight video at the same location as when the user initiated playback of the full length video.

In this way, a user can go back and forth between a highlight video and one or more full length videos from which video segments of the highlight video were drawn.

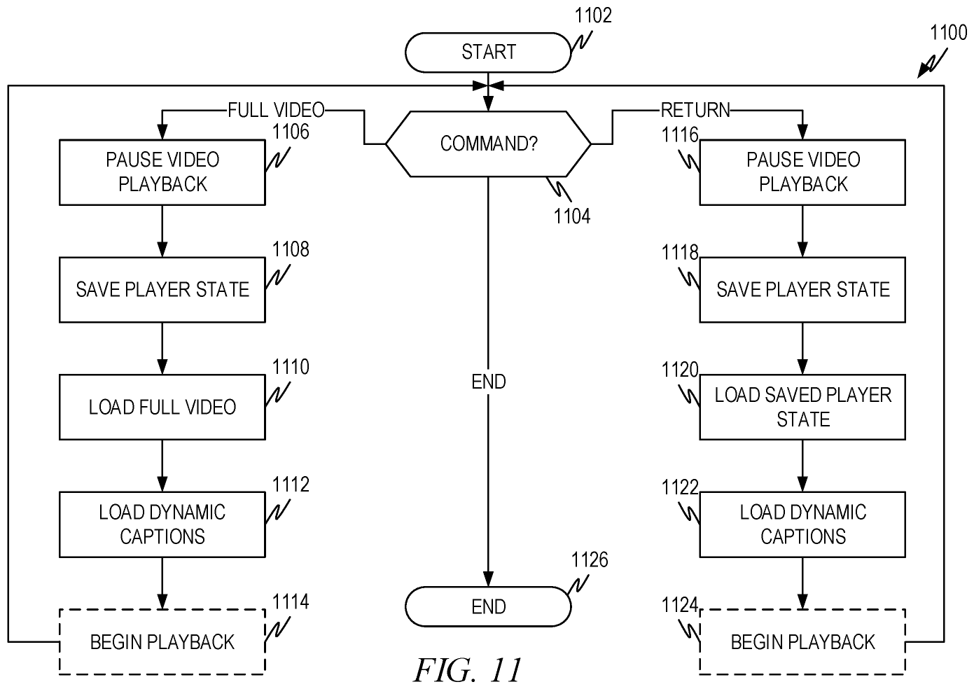

FIG. 11 illustrates an example flow diagram 1100 for switching between segment play of a highlight video and full video play according to some aspects of the present disclosure. The method begins at operation 1102 and proceeds to operation 1104 where the system waits until a command to either initiate playback of a full length video or return to the highlight video is received.

When the user initiates playback of the full video from which a selected video segment is drawn such as by any of the methods described herein, the “full video” command is received and execution proceeds to operation 1106 where playback (if any) of a selected video segment of the highlight video is paused.

Operation 1108 then saves the player state which is a combination of the highlight video definition and/or the video segment playback list and the playback location of the video segment currently being played. Additionally, the player state can include state information such as which metadata attributes have been selected by the user, and so forth to the extent that such information is not otherwise captured.

Operation 1110 loads the full length video along with the appropriate player user interface. The video can be queued to begin playback at an identified location (such as a segment start, the beginning of the full length video, and so forth).

Operation 1112 loads and displays any dynamic captioning as discussed herein.

Playback can automatically begin in operation 1114, or the system can wait until the user initiates playback of the full length video.

When the user wants to return to the highlight video (e.g., change from 1014 back to 1002), the user activates the appropriate control (such as return command. 1016) and/or initiates the appropriate command. Operation 1116 is then executed which pauses the playback (if any) of the full length video.

Operation 1118 saves the current video player state, including the current playback position in the full length video, in case the user wants to return to that location in the full length video.

Operation 1120 loads the highlight video player state (e.g., that was saved as part of operation 1108) and operation 1122 displays the appropriate dynamic captioning,

Playback can automatically begin in operation 1124, or the system can wait until the user initiates playback of the full length video.

If the user desires to end playback, the method ends at operation 1126.

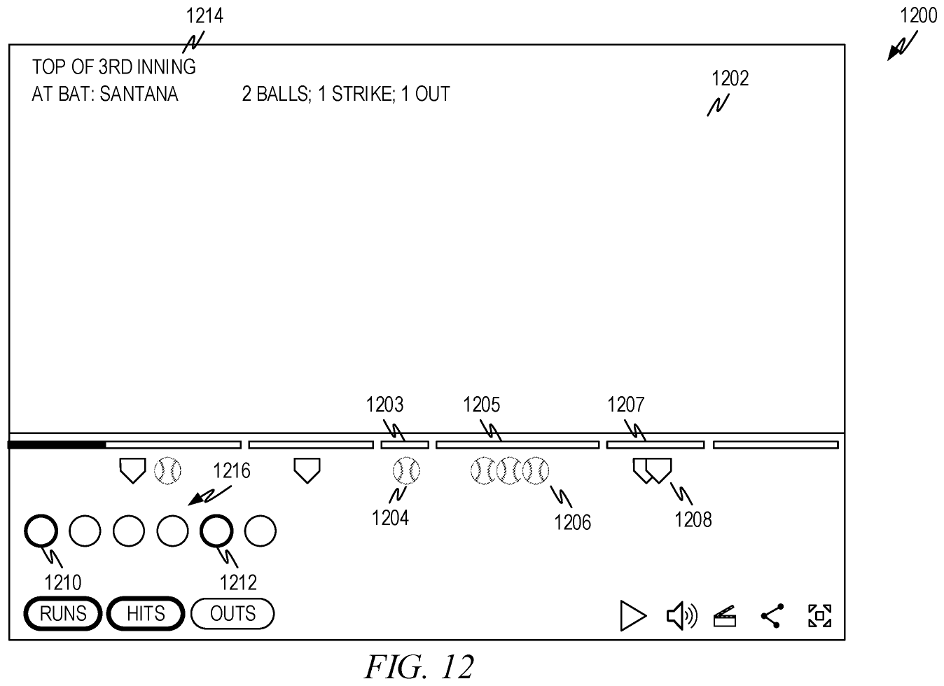

FIG. 12 illustrates an example video player user interface 1200 according to some aspects of the present disclosure. The video player user interface 1200 can share similar features to other video player user interfaces described herein such as any features from any of the other user interface figures and/or description. Thus, a region 1202 where playback of a currently selected video segment is displayed and other previously discussed controls are illustrated. All these can operate as described herein.

FIG. 12 also shows some additional types of dynamic captioning that can be used in any of the user interfaces discussed herein. In this instance, the example highlight video is a highlight video drawn from one or more videos of games between two baseball teams. However, any other subject matter can have similar dynamic captioning.

In this example, the dynamic captioning associated with the underlying full length videos are illustrated by a plurality of baseball team logos 1206 that represent the set of baseball teams from all the video segments. The two teams involved in a current video segment are represented by highlighting (e.g., by color, line width, etc.) the corresponding team icons (e.g., 1210 and 1212). Thus, this type of dynamic captioning conveys both full length video information and video segment information.

Additionally, or alternatively, additional dynamic captioning relating to the current video segment can be displayed such as in the text 1214 which can describe the full video, the current video segment and/or the current event in the current video segment. Note that in this instance the dynamic captioning is rendered (either in an overlay or as part of the video player) over a portion of the area where playback is displayed 1202. Thus, dynamic captioning in embodiments of the present disclosure are not limited to any particular location, but can reside in one or more locations.

In FIG. 12, the display segments are annotated by displaying one or more annotations (e.g., the icons) that describe events and/or other information that occur or are related to the video segment corresponding to the display segment. Thus, display segment 1203 has a baseball icon 1204 displayed in proximity to indicate that the corresponding video segment contains a hit. Display segment 1205 has three baseball icons 1206 indicating three hits in the corresponding video segment. Display segment 1207 has two home plate icons 1208 indicating two runs in the corresponding video segment.

Thus, in some embodiments, icons, symbols, pictures, text, and/or other dynamic captions can be placed in proximity to a display segment indicating content, events, and so forth contained in the corresponding video segment.

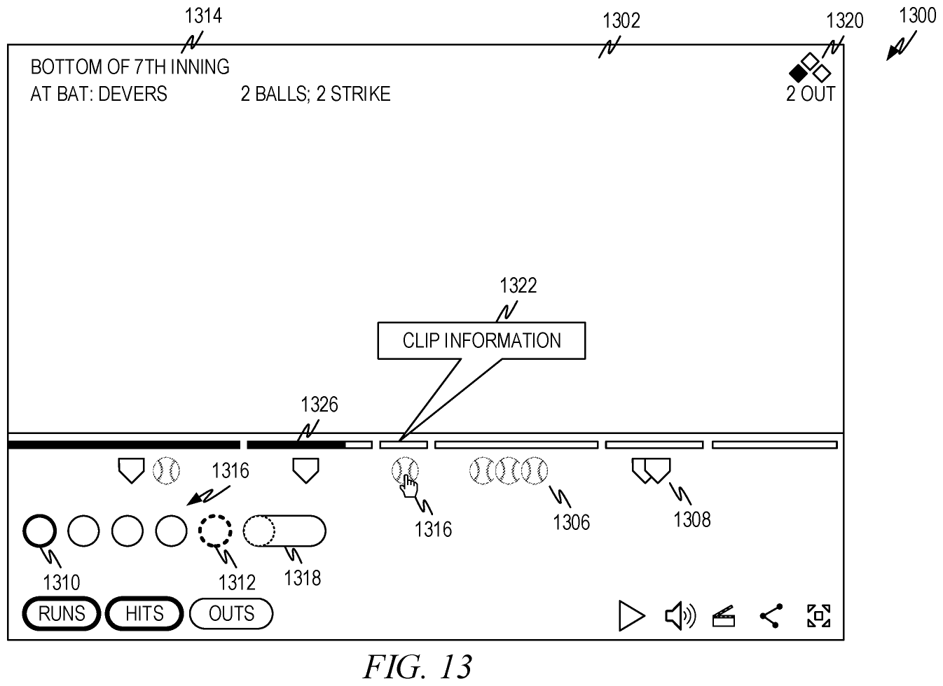

FIG. 13 illustrates an example video player user interface 1300 according to some aspects of the present disclosure. The video player user interface 1300 can share similar features to other video player user interfaces described herein such as any features from any of the other user interface figures and/or description. Thus, a region 1302 where playback of a currently selected video segment is displayed and other previously discussed controls are illustrated. All these can operate as described herein.

FIG. 13 also shows some additional types of dynamic captioning that can be used in any of the user interfaces discussed herein. Furthermore, the embodiment of the figure illustrates that dynamic captioning can be changed with a hover or other gesture/command.,

As in FIG. 12, the dynamic captioning comprises a set of icons 1324 that can represent team logos or other information that is associated with the full length videos from which the video segments are taken. Thus, icon 1310 could be one team and icon 1312. could be another team who are playing each other in the current video segment corresponding to current display segment 1326. The other dynamic captioning 1314 and 1320 are also related. to the current video segment corresponding to current display segment 1326. Additionally, icons or other dynamic captioning such as 1316, 1306, 1308 are rendered in proximity to display segments to show events or other information associated with the video segment corresponding to the display segments.

The currently displayed dynamic captioning can be changed based on a hover or other gesture command. For example if a user hovers over the icon 1316 or corresponding display segment, a popup 1322 of additional information can be displayed to give the user further information. The popup can be graphical such as that illustrated in 906 and/or 1006, textual, or some other type that conveys the appropriate dynamic captioning.

Additionally, or alternatively, the other dynamic captioning can be changed to show dynamic captioning associated with the hovered over and/or selected segment. For example, if the full length video from which the video segment associated with 1316 is drawn contains two different teams, the illustrated teams 1324 can be changed to show what teams are associated with the full length video. For example, if icon 1310 represents the Texas Rangers and they are playing the Boston Red Sox represented by icon 1312 in the current segment 1326, icons 1310 and 1312 can be highlighted or otherwise set apart from the other icons of 1324. Now if a user hovers over 1316 and the corresponding video segment is from the Texas Rangers vs. the Cincinnati Reds, the icon representing the Boston Red Sox 1312 can be deemphasized in some fashion, while the icon 1318 representing the Cincinnati Reds can be emphasized in some fashion so the user can distinguish which teams are playing in the hovered over clip.

Other dynamic captioning such as 1314 and 1320 can also be changed with the hover gesture/command.

Although the various aspects in the user interfaces illustrated herein have been presented in the context of different embodiments, the features shown in any of the embodiments can be combined with features in any other embodiment in any combination. For example, the hover behavior of FIG. 13 can be combined with the user interface FIG. 6 and vice versa. Thus, any features can be combined into an interface. Additionally, the locations depicted for controls, icons, textual information and so forth need not be in the exact locations as shown, except where specified in the disclosure. For example, the icons or other annotation information associated with a display segment are described herein as being rendered proximate to the display segment.

### Example Machine Architecture and Machine-Readable Medium

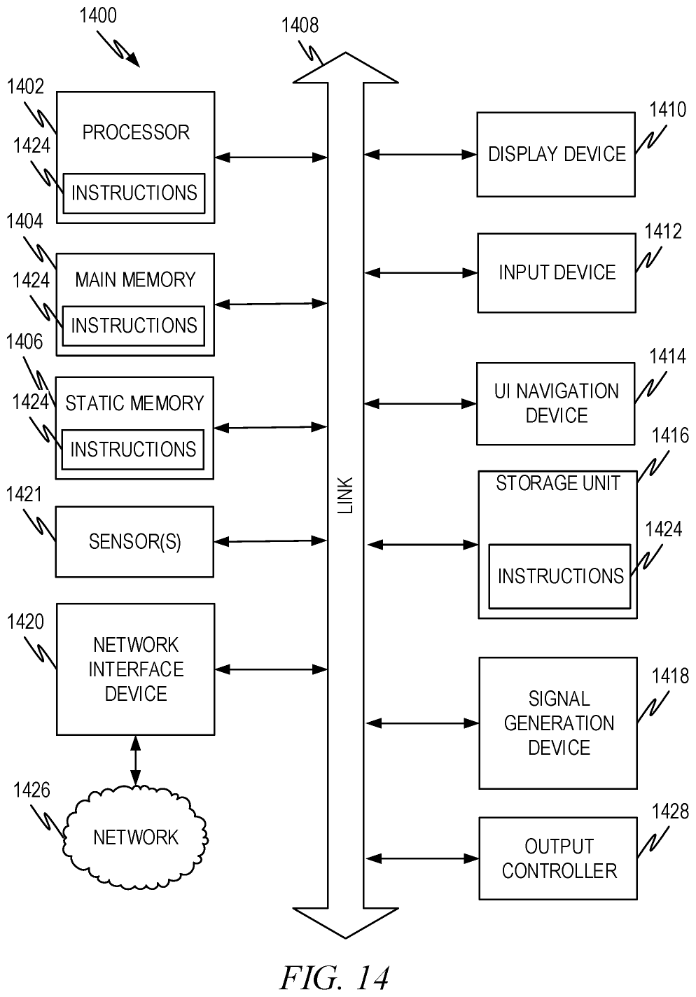

FIG. 14 illustrates a representative machine architecture suitable for implementing the systems and so forth or for executing the methods disclosed herein. The machine of FIG. 14 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 14 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 1400 includes at least one processor 1402 (e.g., a central processing unit (CPU), a graphics processing unit (GPU), advanced processing unit (APU), or combinations thereof), one or more memories such as a main memory 1404, a static memory 1406, or other types of memory, which communicate with each other via link 1408. Link 1408 may be a bus or other type of connection channel. The machine 1400 may include further optional aspects such as a graphics display unit 1410 comprising any type of display. The machine 1400 may also include other optional aspects such as an alphanumeric input device 1412 (e.g., a keyboard, touch screen, and so forth), a user interface (UI) navigation device 1414 (e.g., a mouse, trackball, touch device, and so forth), a storage unit 1416 (e.g., disk drive or other storage device(s)), a signal generation device 1418 (e.g., a speaker), sensor(s) 1421 (e.g., global positioning sensor, accelerometer(s), microphone(s), camera(s), and so forth), output controller 1428 (e.g., wired or wireless connection to connect and/or communicate with one or more other devices such as a universal serial bus (USB), near field communication (NFC), infrared (IR), serial/parallel bus, etc.), and a network interface device 1420 (e.g., wired and/or wireless) to connect to and/or communicate over one or more networks 1426.

### Executable Instructions and Machine-Storage Medium

The various memories(i.e., 1404, 1406, and/or memory of the processor(s) 1402) and/or storage unit 1416 may store one or more sets of instructions and data structures (e.g., software) 1424 embodying or utilized by any one or more of the methodologies or functions described herein. These instructions, when executed by processor(s) 1402 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers') that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

### Signal Medium

The term “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

### EXAMPLE EMBODIMENTS

### Example 1

A method for playback of video on a computing device, comprising:

displaying a user interface for a first instance of a video player on a display device of the computing device, the user interface comprising:

a main video area where video playback occurs (602, 902, 1202, 1302);

a plurality of segment sections each representing a corresponding video segment that can be viewed by a user, each segment section being visually separated from other video segments so that a user can visually discern where one segment section ends, and another segment section begins (604, 606, 608);

a plurality of controls that affect operation of the first instance of the video player (604, 606, 608, 620, 614, 616, 618, 610, 622, 904, 912, 914, 1008, 1010, 1018, 1016, 1203, 1204, 1205, 1206, 1207, 1208. 1326, 1316, 1306. 1308);

receiving a gesture or command activating playback of a selected video segment (804, 1104);

retrieving metadata describing the selected video segment (710, 712); and

presenting the metadata to the user in the user interface (714, 1216, 1214, 1210, 1212, 1314, 1320, 1310, 1312, 1318).

### Example 2

The method of example 1 further comprising:

creating a user interface overlay comprising the metadata; and

wherein the metadata is presented using the overlay.

### Example 3

The method of example 1 or 2 wherein the user interface further comprises a plurality of metadata attributes, each describing an event in one or more video segments, and wherein the method further comprises:

receiving selection, deselection, or both of one or more of the plurality of metadata attributes to form a current set of metadata attributes;

selecting corresponding video segments so that each selected video segment has a. subset of the current set of metadata attributes; and

modifying the plurality of segment selections to match the selected corresponding video segments.

### Example 4

The method of example 1, 2, or 3 wherein the user interface further comprises one or more icons displayed in proximity to each of the plurality of segment sections, each icon representing a metadata attribute associated with the corresponding video segment.

### Example 5

The method of example 1, 2, 3, or 4 further comprising receiving a hover gesture or command over a segment section and, in response to the hover gesture or command:

displaying a popup window in proximity to the segment section, the popup window comprising an image from the clip associated with the segment section.

### Example 6

The method of example 5 wherein the popup window further comprises metadata information from the corresponding video segment.

### Example 7

The method of example 1, 2, 3, 4, 5, or 6 wherein corresponding video segments are drawn from a plurality of different videos.

### Example 8

The method of example 1, 2, 3, 4, 5, 6, or 7 further comprising:

receiving a selection gesture or command indicating selection of a segment section;

responsive to the selection, beginning playback of a full video from which the video segment corresponding to the segment section is drawn.

### Example 9

The method of example 8 further comprising:

instantiating a second instance of the video player;

making the second instance visible and hiding the first instance; and

initiating playback of the full video in the second instance.

### Example 10

The method of example 9 further comprising:

receiving a gesture or command to go back to the first instance; and

responsive to the gesture or command:

terminating playback of the full video; and

hiding the second instance and making the first instance visible.

### Example 11

The method of example 1, 2, 3, 4, 5, 6, or 7 wherein the user interface further comprises:

a control activation of which:

determining a currently selected video segment;

responsive to determining that the currently selected video segment is playing, pausing playback of the currently selected video segment; and

initiating playback of a full video from which the currently selected video segment is taken.

### Example 12

The method of example 1, 2, 3, 4, 5, 6, 7, 8, 9, 10, or 11 wherein the metadata. is presented in a defined area of the user interface.

### Example 13

The method of example 1, 2, 3, 4, 5, 6, 7, 8, 9, 10, or 11 wherein the metadata is presented using an overlay to the user interface.

### Example 14

An apparatus comprising means to perform a method as in any preceding example.

### Example 15

Machine-readable storage including machine-readable instructions, when executed, to implement a method or realize an apparatus as in any preceding example.

### Example 16

A method for playback of video on a computing device, comprising:

displaying a user interface for a first instance of a video player on a display device of the computing device, the user interface comprising:

a main video area where video playback occurs;

a plurality of segment sections each representing a corresponding video segment that can be viewed by a user, each segment section being visually separated from other video segments so that a user can visually discern where one segment section ends, and another segment section begins;

a plurality of controls that affect operation of the first instance of the video player;

receiving a gesture or command activating playback of a selected video segment;

retrieving metadata describing the selected video segment; and

presenting the metadata to the user in the user interface.

### Example 17

The method of example 16 further comprising:

creating a user interface overlay comprising the metadata; and

wherein the metadata is presented using the overlay.

### Example 18

The method of example 16 wherein the user interface further comprises a plurality of metadata attributes, each describing an event in one or more video segments, and wherein the method further comprises:

receiving selection, deselection, or both of one or more of the plurality of metadata attributes to form a current set of metadata attributes;

selecting corresponding video segments so that each selected video segment has a subset of the current set of metadata attributes; and

modifying the plurality of segment selections to match the selected corresponding video segments.

### Example 19

The method of example 16 wherein the user interface further comprises one or more icons displayed in proximity to each of the plurality of segment sections, each icon representing a metadata attribute associated with the corresponding video segment.

### Example 20

The method of example 16 further comprising receiving a hover gesture or command over a segment section and, in response to the hover gesture or command:

displaying a popup window in proximity to the segment section, the popup window comprising an image from the clip associated with the segment section.

### Example 21

The method of example 20 wherein the pop up window further comprises metadata information from the corresponding video segment.

### Example 22

The method of example 16 wherein corresponding video segments are drawn from a plurality of different videos.

### Example 23

The method of example 16 further comprising:

receiving a selection gesture or command indicating selection of a segment section;

responsive to the selection, beginning playback of a full video from which the video segment corresponding to the segment section is drawn.

### Example 24

The method of example 23 further comprising:

instantiating a second instance of the video player;

making the second instance visible and hiding the first instance; and

initiating playback of the full video in the second instance.

### Example 25

The method of example 24 further comprising:

receiving a gesture or command to go back to the first instance; and

responsive to the gesture or command:

terminating playback of the full video; and

hiding the second instance and making the first instance visible.

### Example 26

A system comprising a processor and computer executable instructions, that when executed by the processor, cause the system to perform operations comprising:

displaying a user interface for a first instance of a video player on a display device of the computing device, the user interface comprising:

a main video area where video playback occurs;

a plurality of segment sections each representing a corresponding video segment that can be viewed by a user, each segment section being visually separated from other video segments so that a user can visually discern where one segment section ends, and another segment section begins;

a plurality of controls that affect operation of the first instance of the video player;

receiving a gesture or command activating playback of a selected video segment;

retrieving metadata describing the selected video segment; and

presenting the metadata to the user in the user interface.

### Example 27

The system of example 26 wherein the user interface further comprises:

a control activation of which:

determining a currently selected video segment;

responsive to determining that the currently selected video segment is playing, pausing playback of the currently selected video segment; and

initiating playback of a full video from which the currently selected video segment is taken.

### Example 28

The system of example 26 further comprising:

instantiating a second instance of the video player and wherein playback is initiated on the second instance.

### Example 29

The system of example 26 further comprising:

receiving a gesture or command to terminate playback of to full video and return to the currently selected video segment; and

responsive to receiving the gesture or command to terminate playback of the full video, terminating playback of the full video and returning to playback of the currently selected video segment.

### Example 30

The system of example 29 further comprising:

responsive to determining that the currently selected video segment is playing, storing a current state of the first instance of the video player.

### CONCLUSION

In view of the many possible embodiments to which the principles of the present invention and the forgoing examples may be applied, it should he recognized that the examples described herein are meant to he illustrative only and should not be taken as limiting the scope of the present invention. Therefore, the invention as described herein contemplates all such embodiments as may come within the scope of the following examples and any equivalents thereto.

1. A method for playback of video on a computing device, comprising:
displaying a user interface for a first instance of a video player on a display device of the computing device, the user interface comprising:
a main video area where video playback occurs;
a video timeline that includes a plurality of segment sections each representing a corresponding video segment that can be viewed by a user, each segment section being visually separated from other segment sections to depict where one segment section ends, and another segment section begins, and each segment section having a size to indicate a duration of the corresponding video segment; and
a plurality of controls that affect operation of the first instance of the video player,. wherein the plurality of controls comprises a selectable metadata tag;
receiving a selection of the selectable metadata tag;
based upon the selectable metadata tag being selected, updating the video timeline to one of:
add a first segment section to the video timeline, wherein the first segment section represents a first video segment, and further wherein the first video segment corresponds to the selectable metadata tag; or
remove a second segment section from the video timeline, wherein the second segment section represents a second video segment, and further wherein the second video segment corresponds to the selectable metadata tag.

2. The method of claim 1 further comprising:
receiving an indication that a segment section in the plurality of segment sections has been selected by a user;
retrieving metadata that describes a video segment that corresponds to the segment section that has been selected by the user; and
creating a user interface overlay comprising the metadata, wherein the metadata is presented using the overlay.

3. (canceled)

4. The method of claim 1 wherein the user interface further comprises one or more icons displayed in proximity to each of the plurality of segment sections, each icon representing a metadata attribute associated with the corresponding video segment.

5. The method of claim 1 further comprising receiving a hover gesture or command over a segment section in the plurality of segment sections and, in response to the hover gesture or command:
displaying a popup window in proximity to the segment section, the popup window comprising an image from a video associated with the segment section.

6. The method of claim 5 wherein the popup window further comprises metadata information from the corresponding video segment.

7. The method of claim 1 wherein video segments that correspond to the plurality of segment sections are drawn from a plurality of different videos.

8. The method of claim 1 further comprising:
receiving a selection gesture or command indicating selection of a segment section in the plurality of segment sections; and
responsive to the selection, beginning playback of a full video from which the video segment corresponding to the segment section is drawn.

9. The method of claim 8 further comprising:
instantiating a second instance of the video player;
making the second instance visible and hiding the first instance; and
initiating playback of the full video in the second instance.

10. The method of claim 9 further comprising:
receiving a gesture or command to go back to the first instance; and
responsive to the gesture or command:
terminating playback of the full video; and
hiding the second instance and making the first instance visible.

11. A system comprising a processor and computer executable instructions, that when executed by the processor, cause the system to perform operations comprising:
displaying a user interface for a first instance of a video player on a display device of a computing device, the user interface comprising:
a main video area where video playback occurs;
a video timeline that includes a plurality of segment sections each representing a corresponding video segment that can be viewed by a user, each segment section being visually separated from other segment sections to visually depict where one segment section ends, and another segment section begins, and each segment section having a size to indicate a duration of the corresponding video segment; and
a plurality of controls that affect operation of the first instance of the video player, wherein the plurality of controls comprises a selectable metadata tag;
receiving a selection of the selectable metadata tag;
based upon the selectable metadata tag being selected, updating the video timeline to one of:
add a first segment section to the video timeline, wherein the first segment section represents a first video segment, and further wherein the first video segment corresponds to the selectable metadata tag; or
remove a second segment section from the video timeline, wherein the second segment section represents a second video segment, and further wherein the second video segment corresponds to the selectable metadata tag.

12. The system of claim 11 wherein the user interface further comprises:
a control, wherein activation of the control causes the system to perform acts comprising:
determining a currently selected video segment;
responsive to determining that the currently selected video segment is playing, pausing playback of the currently selected video segment; and
initiating playback of a full video from which the currently selected video segment is taken.

13. The system of claim 12, the acts further comprising:
instantiating a second instance of the video player and wherein playback is initiated on the second instance.

14. The system of claim 12, the acts further comprising:
receiving a gesture or command to terminate playback of the full video and return to the currently selected video segment; and
responsive to receiving the gesture or command to terminate playback of the full video, terminating playback of the full video and returning to playback of the currently selected video segment.

15. The system of claim 14, the acts further comprising:
responsive to determining that the currently selected video segment is playing, storing a current state of the first instance of the video player.

16. The system of claim 14, the acts further comprising:
responsive to determining that the currently selected video segment is playing, storing a current state of the first instance of the video player; and
responsive to receiving a gesture or command to terminate playback of the full video and return to the currently selected video segment, restoring the current state of the first instance of the video player.

17. The system of claim 11, the operations further comprising:
determining a currently selected video segment;
responsive to determining that a currently selected video segment is playing, pausing playback of the currently selected video segment;
instantiating a second instance of the video player;
making the second instance visible and hiding the first instance;
initiating playback of a full video from which the currently selected video segment is taken;
receiving a gesture or command to go back to the first instance; and
responsive to the gesture or command:
terminating playback of the full video; and
hiding the second instance and making the first instance visible.

18. A computer storage medium comprising executable instructions that, when executed by a processor of a machine, cause the machine to perform operations comprising:
displaying a user interface for a first instance of a video player on a display device of a computing device, the user interface comprising:
a main video area where video playback occurs;
a plurality of segment sections each representing a corresponding video segment that can be viewed by a user, each segment section being visually separated from other segment sections to visually depict where one segment section ends, and another segment section begins, and each segment section having a size to indicate a duration of the corresponding video segment;
a plurality of controls that affect operation of the first instance of the video player, wherein the plurality of controls comprises a selectable metadata tag;
receiving an indication that the selectable metadata tag has been selected;
based upon the selectable metadata tag being selected, updating the video timeline to one of:
add a first segment section to the video timeline, wherein the first segment section represents a first video segment, and further wherein the first video segment corresponds to the selectable metadata tag; or
remove a second segment section from the video timeline, wherein the second segment section represents a second video segment, and further wherein the second video segment corresponds to the selectable metadata tag.

19. The computer storage medium of claim 18, the operations further comprising:
receiving a selection of a segment section in the plurality of segment sections; and
presenting metadata that describes a video segment that corresponds to the segment selection in a defined area of the user interface.

20. The computer storage medium of claim 19 wherein the metadata is presented using an overlay to the user interface.

21. The method of claim 1, wherein the plurality of segment sections represent streamed video gaming sessions.
